(19) United States
(12) Patent Application Publication
(10) Pub. No.: US 2003/0008565 A1
(43) Pub. Date: Jan. 9, 2003

(54) Serial advanced technology adapter power connector adapter

(76) Inventor: Che-Chia Chang, Taipei (TW)

Correspondence Address: TROXELL LAW OFFICE PLLC, 5205 LEESBURG PIKE, SUITE 1404, Falls Church, VA, 22041, US

(21) Appl. No.: 09/899,336

(22) Filed: Jul. 5, 2001

(51) Int. Cl. H01R 25/00; H01R 27/02; H01R 31/00; H01R 33/88; H01R 33/90; H01R 33/92; H01R 33/94

(52) U.S. Cl. 439/638

(57) ABSTRACT

The present invention provides a legacy power supply to serial advanced technology adapter (SATA) device and SATA power to legacy device adapter which provides means for connecting legacy devices to computer systems utilizing SATA power connections and for connecting devices with SATA power connections to legacy computer systems. The power adapter of the present invention comprises a dual-ended adapter connector. The legacy connection end of the adapter connects to the 4-pin legacy switching power supply output connector and the 15-pin SATA connection end connects to a computer system device connector. Therefore, the power adapter of the present invention provides an inexpensive and convenient means of connecting a power supply output to a system device regardless of the incompatible interface connectors.

### BACKGROUND OF THE INVENTION

1. Field of Invention

The present invention relates generally to a power connector adapter. More particularly, the present invention relates to a legacy power to serial advanced technology adapter (SATA) power connector adapter and SATA power to legacy power connector adapter.

2. Description of the Related Art

In a conventional computer system, power is provided to the motherboard and internal devices via a switching power supply. The switching power supply receives 110-volt AC from an external source such as an electrical outlet or uninterruptible power source ((UPS). The switching power supply then converts the 110-volt AC and supplies the computer system with +3.3, +5, and +12 volts DC along with ground.

The conventional power supply output connector that connects to the system devices is a four-pin connector. However, next generation devices can have different power supply requirements. Problems arise when new devices are installed in an older computer system or when old devices are installed in new systems as the connecting interface or power requirements have changed.

Therefore, a need exists for a convenient and efficient way of providing legacy support for devices and computer systems that have different voltage requirements.

### SUMMARY OF THE INVENTION

In order to overcome the disadvantages of the conventional power supply connection interface, the present invention provides a legacy power to serial advanced technology adapter (SATA) power and SATA power to legacy power adapter which provides means for connecting existing devices to computer systems utilizing SATA power and for connecting devices with SATA power connections to existing computer systems.

New SATA devices will have a 15-pin power connector. Also, new SATA power supplies will have a 15-pin output connector to mate with the 15-pin power connector of the SATA device. The conventional power supply output connector and conventional device connectors are four-pin connectors. Therefore, during the transition from the current power supply system to the SATA power system, interface problems will arise when trying to connect power supplies and devices with different power supply interfaces.

The power adapter of the present invention comprises a dual-ended adapter connector. One end of the adapter connects to the switching power supply output connector and the other end connects to a computer system device. Such devices are, for example, hard disk, cd-rom, dvd, or floppy disk drives.

The power adapter of the present invention conveniently mates the appropriate gender of the power supply output connector and the device connector allowing the proper voltage to be provided at the correct pin location to the device connector.

Therefore, the power adapter of the present invention provides an inexpensive and convenient means of connecting a power supply output to a system device regardless of the incompatible interface connectors.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is an illustration showing a legacy power supply to SATA device adapter in accordance with an embodiment of the present invention;

FIG. 2 is an illustration showing a legacy power supply to SATA device adapter in accordance with an embodiment of the present invention;

FIG. 3 is an illustration showing an SATA power supply to legacy device adapter in accordance with an embodiment of the present invention; and

FIG. 4 is an illustration showing an SATA power supply to legacy device adapter in accordance with an embodiment of the present invention.

### DETAILED DESCRIPTION OF THE PREFERRED EMBODIMENTS

In order to overcome the disadvantages of the conventional power supply connection interface, the present invention provides a legacy power supply to serial advanced technology adapter (SATA) device and SATA power to legacy device adapter which provides means for connecting legacy devices to computer systems utilizing SATA power and for connecting devices with SATA power connections to legacy computer systems.

New SATA devices have a 15-pin power connector. Also, new SATA power supplies have a 15-pin output connector to mate with the 15-pin power connector of the SATA device. The conventional power supply output connector and conventional device connectors are four-pin connectors. Therefore, during the transition from the current power supply system to the SATA power system, interface problems will arise when trying to connect power supplies and devices with different power supply interfaces.

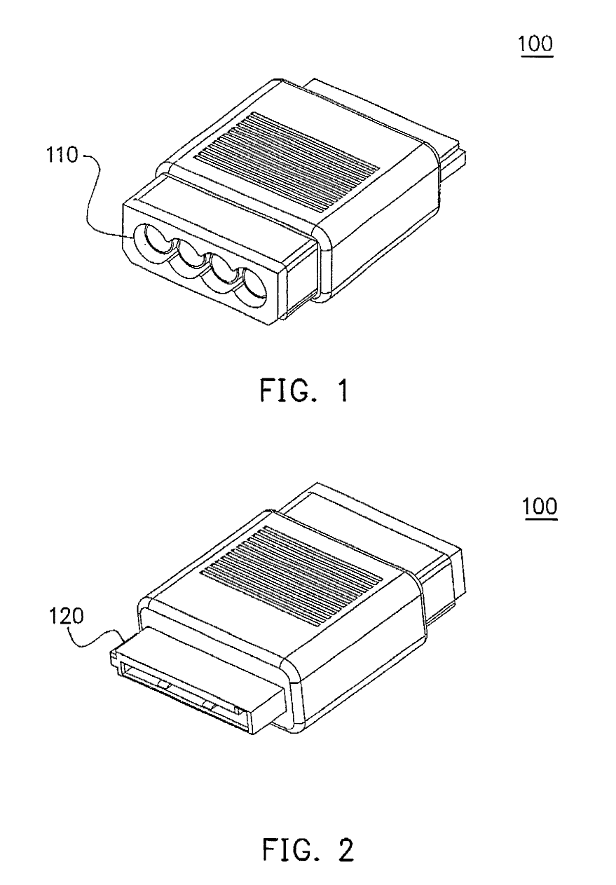

Refer to FIG. 1, which is an illustration showing a legacy power supply to SATA device adapter in accordance with an embodiment of the present invention and FIG. 2, which is an illustration showing a legacy power supply to SATA device adapter in accordance with an embodiment of the present invention. FIG. 1 more clearly illustrates the legacy power supply adapter connection and FIG. 2 more clearly illustrates the SATA device adapter connection.

The power adapter 100 of the present invention comprises a dual-ended adapter connector. The legacy end 110 of the adapter connects to the switching power supply output connector (not shown) and the SATA end 120 connects to a computer system device connector (not shown). Such devices are, for example, hard disk, cd-rom, dvd, or floppy disk drives. In an embodiment of the present invention, the power adapter 100 as illustrated in FIGS. 1 and 2, is for connecting a legacy power supply to an SATA device.

The legacy power supply output connector is a four-pin plug connector. Therefore, in order to correctly mate with the legacy power supply output connector, the power adapter 100 of the present invention comprises a four-pin receptacle connector end 110. The SATA device power input connector is a 15-pin SATA receptacle connector. Therefore, in order to correctly mate with the SATA device power input connector, the power adapter 100 of the present invention comprises a 15-pin SATA plug connector end 120.

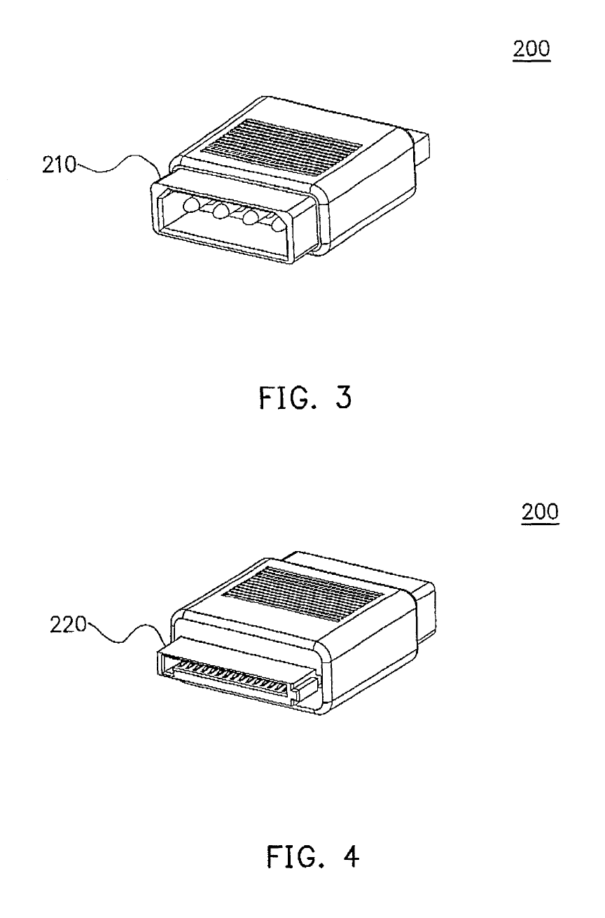

Refer to FIG. 3, which is an illustration showing an SATA power supply to legacy device adapter in accordance with an embodiment of the present invention and FIG. 4, which is an illustration showing an SATA power supply to legacy device adapter in accordance with an embodiment of the present invention. FIG. 3 more clearly illustrates the legacy device adapter connection and FIG. 4 more clearly illustrates the SATA power supply adapter connection.

In another embodiment of the present invention, the power adapter 200 of the present invention comprises a dual-ended adapter connector. The legacy device connection end 210 of the adapter connects to the legacy device input connector (not shown) and the SATA power supply connection end 220 connects to an SATA power supply output connector (not shown). In an embodiment of the present invention, the power adapter 200 as illustrated in FIGS. 3 and 4, is for connecting an SATA power supply to a legacy device.

The legacy device input connector is a four-pin receptacle connector. Therefore, in order to correctly mate with the legacy device input connector, the power adapter 200 of the present invention comprises a four-pin plug connector end 210. The SATA power supply output connector is a 15-pin SATA plug connector. Therefore, in order to correctly mate with the SATA power supply output connector, the power adapter 200 of the present invention comprises a 15-pin SATA receptacle connector end 220.

The SATA power requirement is to support power delivery with 12.0 V, 5.0 V, and 3.3 V voltages. Therefore, both legacy power supplies and SATA power supplies support power delivery of the same voltages. However, their connection interfaces are incompatible. The SATA power connector is a 15-pin SATA connector. The pin definitions are as follows pin 1, pin 2, and pin 3=3.3 volts power; pin 4, pin 5, and pin 6 = ground; pin 7, pin 8, and pin 9=5 volts power; pin 10, pin 11, and pin 12= ground; pin 13, pin 14, and pin 15=12 volts power. The connectors or ends of the power adapter of the present invention are electrically coupled in such a way as to allow the proper power from the power supply output to be provided to the device at the correct pin location.

Whereas in some embodiments of the present invention, the power adapter is a dual-ended adapter encased in a housing, in other embodiments of the present invention, the power adapter comprises a length of cabling between the two adapter connections The additional length of cabling between the two adapter connections allows for convenient routing and connection of the power supply and device. The length of cabling is variable depending upon requirements and positioning of the power supply and device.

In another embodiment of the present invention, the power adapter comprises a printed circuit board (PCB) containing wire traces that electrically couple the two adapter connections. The pcb wire routing is such that the power supply power is correct routed to the proper pin location of the device connector input.

Additionally, in other embodiments of the present invention the gender of the adapter connections can be changed in order to conform to specific system requirements For example, plug connectors can be exchanged for receptacle connectors and receptacle connectors can be exchanged for plug connectors.

The power adapter of the present invention conveniently mates the appropriate type and gender of the power supply output connector with the appropriate type and gender of the device input connector allowing the power supply to provide the proper voltage at the correct pin location to the device input connector.

For example, if an older computer system is to be upgraded with a new SATA hard disk drive, the 4-pin legacy power supply output connector cannot mate with the 15-pin SATA hard disk drive power input connector. Utilizing the power adapter of the present invention, the 4-pin legacy power supply output connector is connected to the 4-pin adapter connection of the present invention and the 15-pin SATA adapter connection is connected to the 15-pin SATA power input connector of the SATA hard disk drive.

In another example, if a new computer system using an SATA power supply needs to have a legacy hard disk drive installed, the 15-pin SATA power supply output connector cannot mate with the 4-pin legacy hard disk drive power input connector. Utilizing the power adapter of the present invention, the 15-pin SATA power supply output connector is connected to the 15-pin SATA adapter connection of the present invention and the 4-pin legacy adapter connection of the present invention is connected to the 4-pin legacy hard disk drive power input connector.

Therefore, the power adapter of the present invention provides an inexpensive and convenient means of connecting a power supply output to a system device regardless of the incompatible interface connectors.

In addition, the power adapter of the present invention eliminates system redundancy and lowers manufacturing costs since there is no need to provide legacy power support connections in addition to SATA power connections. Utilizing the power adapter of the present invention, device, power, and computer systems manufacturers only need to supply product with one type of connector interface instead of two, thus saving manufacturing costs and eliminating backward compatibility problems.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A power adapter comprising:
a legacy power connector for connecting to a legacy power output connector of a power supply; and
a serial advanced technology adapter power connector for connecting to a serial advanced technology adapter power input connector of a device; wherein the legacy power connector and serial advanced technology adapter power connector are electrically coupled so that power output by the power supply is provided to the device.

2. The power adapter of claim 1, wherein the legacy power connector and the serial advanced technology adapter power connector are electrically coupled via a length of cabling.

3. The power adapter of claim 1, wherein the legacy power connector and the serial advanced technology adapter power connector are electrically coupled via a printed circuit board.

4. The power adapter of claim 1, wherein the legacy power connector is a four-pin legacy power receptacle connector and the serial advanced technology adapter power connector is a 15-pin serial advanced technology adapter power plug connector.

5. The power adapter of claim 1, wherein the legacy power connector is a four-pin legacy power plug connector and the serial advanced technology adapter power connector is a 15-pin serial advanced technology adapter power receptacle connector.

6. A power adapter comprising:
A dual-ended housing comprising a legacy power connector end and a serial advanced technology adapter power connector end;
Wherein the legacy power connector end and the serial advanced technology adapter power connector end are electrically coupled therefore providing a compatible interface for legacy power and serial advanced technology adapter power

7. The power adapter of claim 5, wherein the legacy power connector end and the serial advanced technology adapter power connector end are electrically coupled via a length of cabling.

8. The power adapter of claim 5, wherein the legacy power connector and the serial advanced technology adapter power connector are electrically coupled via a printed circuit board.

9. The power adapter of claim 5, wherein the legacy power connector end is a four-pin legacy power receptacle connector and the serial advanced technology adapter power connector end is a 15-pin serial advanced technology adapter power plug connector.

10. The power adapter of claim 5, wherein the legacy power connector end is a four-pin legacy power plug connector and the serial advanced technology adapter power connector end is a 15-pin serial advanced technology adapter power receptacle connector.

11. A power adapter comprising:
A four-pin legacy power connector for connecting to a four-pin legacy power output connector of a power supply; and
a 15-pin serial advanced technology adapter power connector for connecting to a 15-pin serial advanced technology adapter power input connector of a device; wherein the legacy power connector and serial advanced technology adapter power connector are electrically coupled so that power output by the legacy power supply is provided to the serial advanced technology adapter device.

12. The power adapter of claim 9, wherein the four-pin legacy power connector and the 15-pin serial advanced technology adapter power connector are electrically coupled via a length of cabling.

13. The power adapter of claim 9, wherein the legacy power connector and the serial advanced technology adapter power connector are electrically coupled via a printed circuit board.

14. The power adapter of claim 9, wherein the 4-pin legacy power connector is a four-pin legacy power receptacle connector and the 15-pin serial advanced technology adapter power connector is a 15-pin serial advanced technology adapter power plug connector.

15. The power adapter of claim 9, wherein the 4-pin legacy power connector is a four-pin legacy power plug connector and the 15-pin serial advanced technology adapter power connector is a 15-pin serial advanced technology adapter power receptacle connector.

16. A power adapter comprising:
A four-pin legacy power connector for connecting to a four-pin legacy power input connector of a legacy device; and
a 15-pin serial advanced technology adapter power connector for connecting to a 15-pin serial advanced technology adapter power supply output connector; wherein the legacy power connector and serial advanced technology adapter power connector are electrically coupled so that power output by the serial advanced technology adapter power supply is provided to the legacy device.

17. The power adapter of claim 13, wherein the legacy power connector and the serial advanced technology adapter power connector are electrically coupled via a length of cabling.

18. The power adapter of claim 13, wherein the legacy power connector and the serial advanced technology adapter power connector are electrically coupled via a printed circuit board.

19. The power adapter of claim 13, wherein the four-pin legacy power connector is a four-pin legacy power receptacle connector and the 15-pin serial advanced technology adapter power connector is a 15-pin serial advanced technology adapter power plug connector.

20. The power adapter of claim 13, wherein the four-pin legacy power connector is a four-pin legacy power plug connector and the 15-pin serial advanced technology adapter power connector is a 15-pin serial advanced technology adapter power receptacle connector.
